(19) United States
(12) Patent Application Publication
(10) Pub. No.: US 2024/0266682 A1
(43) Pub. Date: Aug. 8, 2024

(54) A MULTI-CELL RECHARGEABLE ENERGY STORAGE DEVICE

(71) Applicant: GM GLOBAL TECHNOLOGY OPERATIONS LLC, Detroit, MI (US)

(72) Inventors: Shifang Li, Shelby Twp., MI (US); William T. Kucinski, Windsor (CA); Jacob Friedrich, Willoughby, OH (US); Mitchell Stojanovski, Oak Park, MI (US); Annabella Wong, Clawson, MI (US); Kyle Whittaker, Royal Oak, MI (US); Hunter G. Rimatzki, Clawson, MI (US); Kristopher A. Thor, Novi, MI (US)

(73) Assignee: GM GLOBAL TECHNOLOGY OPERATIONS LLC, Detroit, MI (US)

(21) Appl. No.: 18/166,467

(22) Filed: Feb. 8, 2023

(51) Int. Cl. H01M 50/507; B60L 50/60; H01M 10/42; H01M 10/613; H01M 10/6555; H01M 50/213; H01M 50/296; H01M 50/51

(52) U.S. Cl. CPC H01M 50/507; B60L 50/60; H01M 10/425; H01M 10/613; H01M 10/6555; H01M 50/213; H01M 50/296; H01M 50/51; H01M 2010/4271; H01M 2220/20

(57) ABSTRACT

A multi-cell rechargeable energy storage system has battery cells disposed in an enclosure, and arranged in cell modules. Collectors are arranged to electrically connect the battery cells arranged in the cell modules. An electric power bus is arranged in a spine, and terminates at positive and negative terminals. First busbars, a second busbar, and end collectors electrically connect the cell modules in series between the positive terminal and the second terminal. Cell monitoring controllers are arranged to monitor the cell modules. A potting compound is arranged to encapsulate only an upper portion of the battery cells. A thermal management system including first and second fluidic manifolds are fluidly coupled to longitudinal heat exchange plates to thermally couple to the battery cells.

### INTRODUCTION

Rechargeable energy storage devices and systems may be employed in a stationary energy storage system or in a mobile device, e.g., as part of an electric vehicle (EV). When employed as part of an EV, an electrified powertrain employs one or multiple electric machines to generate torque employing energy derived at least in part from the rechargeable energy storage device, with the generated torque being delivered to a drivetrain for tractive effort.

### SUMMARY

There is a need for a multi-cell rechargeable energy storage device and/or system that has a hybrid orientation of electrical and thermal systems to enable efficient cell integration, achieve electrical energy storage requirements, and fit within allowable packaging dimensions, along with other features that may be achieved by such an arrangement.

The concepts described herein provide for a multi-cell rechargeable energy storage device and/or system, employable on-vehicle, that has a plurality of cylindrical-shaped battery cells, wherein the plurality of cylindrical-shaped battery cells are disposed in an enclosure, and wherein the plurality of cylindrical-shaped battery cells are arranged in a plurality of cell modules. A plurality of longitudinally-oriented collectors are arranged to electrically connect the cylindrical-shaped battery cells arranged in the plurality of cell modules. A plurality of end collectors are arranged on first and second sides of the enclosure. A positive terminal and a negative terminal are both arranged proximal to a first end of the enclosure. An electric power bus is arranged in a longitudinally-oriented spine, and terminates at the positive terminal and the negative terminal. The electric power bus includes a plurality of first busbars and a second busbar. The plurality of first busbars, the second busbar, and the plurality of end collectors are arranged to electrically connect the plurality of cell modules in series between the positive terminal and the second terminal. A plurality of cell monitoring controllers arranged to monitor the plurality of cell modules. A potting compound is arranged to encapsulate only an upper portion of the plurality of cylindrical-shaped battery cells and the plurality of collectors within the enclosure. A thermal management system including first and second fluidic manifolds are fluidly coupled to a plurality of longitudinal heat exchange plates, wherein the plurality of longitudinal heat exchange plates are arranged to thermally couple to the plurality of cylindrical-shaped battery cells.

An aspect of the disclosure may include the plurality of first busbars, the second busbar, and the plurality of end collectors being arranged in a serpentine configuration to electrically connect the plurality of cell modules in series between the positive device terminal and the negative device terminal.

Another aspect of the disclosure may include a potting compound, wherein the potting compound is arranged to encapsulate only an upper portion of the plurality of battery cells and the plurality of collectors within the enclosure.

Another aspect of the disclosure may include the positive device terminal and the negative device terminal being arranged proximal to a first end of the enclosure.

Another aspect of the disclosure may include a plurality of cell monitoring controllers being arranged to monitor the plurality of cell modules.

Another aspect of the disclosure may include each of the plurality of cell monitoring controllers being arranged to monitor electrical parameters and environmental parameters of a respective one of the plurality of cell modules.

Another aspect of the disclosure may include the plurality of cell modules projecting laterally outwardly from the longitudinally-oriented spine.

Another aspect of the disclosure may include the battery cells of one of the plurality of cell modules being arranged into a plurality of subsets that are arranged in parallel, wherein one of the plurality of longitudinally-oriented collectors is arranged to electrically connect a first of the plurality of subsets of the battery cells to second of the plurality of subsets of the battery cells.

Another aspect of the disclosure may include the plurality of cell modules being arranged symmetrically around the longitudinally-oriented spine.

Another aspect of the disclosure may include the plurality of longitudinal heat exchange plates being arranged to physically contact the portion of the outer surface of the plurality of battery cells to thermally couple to the plurality of battery cells.

Another aspect of the disclosure may include a potting material that encapsulates only an upper portion of the plurality of battery cells.

Another aspect of the disclosure may include a void area that is defined by the potting material that encapsulates the upper portion of the plurality of battery cells, and the enclosure.

Another aspect of the disclosure may include the plurality of first busbars of the electric power bus being arranged in a vertical stack in the longitudinally-oriented spine.

Another aspect of the disclosure may include the plurality of first busbars of the electric power bus being electrically connected to a plurality of vertically-arranged bosses.

Another aspect of the disclosure may include a battery disconnect unit, wherein the plurality of vertically-arranged bosses are electrically connected to the battery disconnect unit.

Another aspect of the disclosure may include a vehicle having a rechargeable energy storage system that is electrically connected to an electric drive system coupled to a propulsion unit. The rechargeable energy storage system includes a plurality of cylindrical-shaped electrochemical battery cells, wherein the plurality of battery cells are disposed in an enclosure, and wherein the plurality of battery cells are arranged into a plurality of cell modules; a plurality of longitudinally-oriented collectors, wherein the plurality of longitudinally-oriented collectors are arranged to electrically connect the battery cells arranged in the plurality of cell modules; a plurality of end collectors arranged on first and second sides of the enclosure; a positive device terminal and a negative device terminal; and an electric power bus arranged in a longitudinally-oriented spine, wherein the electric power bus includes a plurality of first busbars and a second busbar. The plurality of first busbars, the second busbar, and the plurality of end collectors are arranged to electrically connect the plurality of cell modules in series between the positive device terminal and the negative device terminal. A thermal management system including first and second fluidic manifolds that are fluidly coupled to a plurality of longitudinally-oriented heat exchange plates. The plurality of longitudinally-oriented heat exchange plates are arranged to physically contact a portion of an outer surface of the plurality of battery cells. Another aspect of the disclosure may include a rechargeable energy storage system that includes a plurality of electrochemical battery cells (battery cells), wherein the plurality of battery cells are disposed in an enclosure, and wherein the plurality of battery cells are arranged into a plurality of cell modules; a plurality of collectors, wherein the plurality of collectors are arranged to electrically connect the battery cells arranged in the plurality of cell modules; a plurality of end collectors arranged on first and second sides of the enclosure; a positive device terminal and a negative device terminal; an electric power bus arranged in a spine, wherein the electric power bus includes a plurality of first busbars and a second busbar; wherein the plurality of first busbars, the second busbar, and the plurality of end collectors are arranged to electrically connect the plurality of cell modules in series between the positive device terminal and the negative device terminal; and a thermal management system fluidly coupled to a plurality of heat exchange plates; wherein the plurality of heat exchange plates are arranged to physically contact a portion of an outer surface of the plurality of battery cells.

The above summary is not intended to represent every possible embodiment or every aspect of the present disclosure. Rather, the foregoing summary is intended to exemplify some of the novel aspects and features disclosed herein. The above features and advantages, and other features and advantages of the present disclosure, will be readily apparent from the following detailed description of representative embodiments and modes for carrying out the present disclosure when taken in connection with the accompanying drawings and the claims.

### BRIEF DESCRIPTION OF THE DRAWINGS

One or more embodiments will now be described, by way of example, with reference to the accompanying drawings, in which:

FIG. 1 schematically illustrates a vehicle including a rechargeable energy storage device, in accordance with the disclosure.

FIG. 2 illustrates a top view of an embodiment of the rechargeable energy storage system, in accordance with the disclosure.

FIG. 3 illustrates a top view of a portion of an embodiment of the rechargeable energy storage system, in accordance with the disclosure.

FIG. 4 illustrates an isometric view of a portion of an embodiment of the rechargeable energy storage system, in accordance with the disclosure.

FIG. 5 illustrates a top view of an embodiment of the rechargeable energy storage system, in accordance with the disclosure.

FIG. 6 illustrates an isometric view of a longitudinally-oriented spine and busbar for an embodiment of the rechargeable energy storage system, in accordance with the disclosure.

FIG. 7 illustrates an isometric view of a busbar connector for a longitudinally-oriented spine for an embodiment of the rechargeable energy storage system, in accordance with the disclosure.

FIG. 8 illustrates an isometric view of a cooling system for an embodiment of the rechargeable energy storage system, in accordance with the disclosure.

FIG. 9 illustrates a partial cutaway view of an embodiment of the rechargeable energy storage system, in accordance with the disclosure.

The present disclosure is susceptible to various modifications and alternative forms, and some representative embodiments have been shown by way of example in the drawings and will be described in detail herein. Novel aspects of this disclosure are not limited to the forms illustrated in the drawings. Rather, the disclosure is intended to cover modifications, equivalents, combinations, or alternatives falling within the spirit and scope of the disclosure as defined by the appended claims.

### DETAILED DESCRIPTION

The following detailed description is merely exemplary in nature and is not intended to limit the application and uses. Furthermore, the drawings are in simplified form and are not to precise scale. For purposes of convenience and clarity only, directional terms such as top, bottom, left, right, up, over, above, below, beneath, rear, and front, and similar expressions are employed for description, and are not to be construed to limit the scope of the disclosure.

Furthermore, the disclosure, as illustrated and described herein, may be practiced in the absence of an element that is not specifically disclosed herein.

The use of ordinals such as first, second and third does not necessarily imply a ranked sense of order, but rather may only distinguish between multiple instances of an act or structure.

As used herein, the term “system” may refer to one of or a combination of mechanical and electrical actuators, sensors, controllers, application-specific integrated circuits (ASIC), combinatorial logic circuits, software, firmware, and/or other components that are arranged to provide the described functionality. The use of ordinals such as first, second and third does not necessarily imply a ranked sense of order, but rather may only distinguish between multiple instances of an act or structure.

Throughout the drawings, the various elements may be described in context of a longitudinal axis 11, a lateral axis 12, and/or a vertical axis 13.

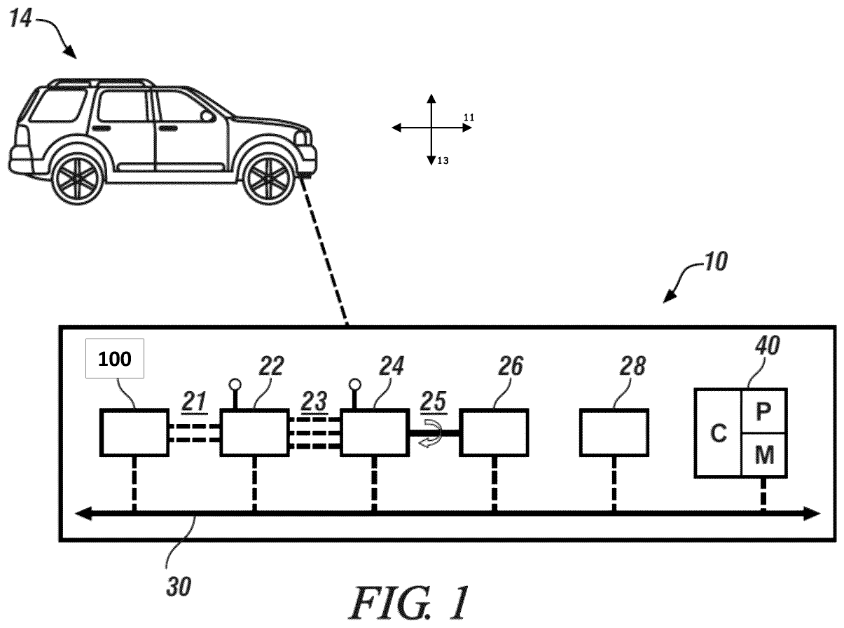

Referring to the drawings, wherein like reference numbers refer to like components, FIG. 1 schematically illustrates an electric drive system 10 arranged to supply tractive torque to a vehicle 14. Operation of the electric drive system 10 is controlled by a controller C 40. The electric drive system 10 may be an electric drive system or a hybrid drive system that employs one or multiple rotary electric machines to generate mechanical torque. The vehicle 14 may include, but not be limited to a mobile platform in the form of a commercial vehicle, industrial vehicle, agricultural vehicle, passenger vehicle, aircraft, watercraft, train, all-terrain vehicle, personal movement apparatus, robot and the like to accomplish the purposes of this disclosure. Alternatively, the electric drive system 10 may be arranged to supply torque to a stationary system. It is to be understood that the electric drive system 10 may take many different forms and have additional components. A longitudinal dimension of the vehicle 14 defines the longitudinal axis 11, a lateral dimension of the vehicle 14 defines the lateral axis 12, and a vertical dimension of the vehicle 14 defines the vertical axis 13.

The electric drive system 10 includes a DC power source such as a rechargeable energy storage unit (battery) 100. The electric drive system 10 includes a power inverter 22 and rotary electric machine 24. The rechargeable energy storage system 100 is electrically connected to the power inverter 22 via a high-voltage DC power bus 21, and the power inverter 22 is connected to the rotary electric machine 24 via electrical conductors 23. The rotary electric machine 24 is mechanically coupled to a propulsion unit 26 via a rotatable member 25. The rechargeable energy storage system 100 may be a traction battery pack for generating high-voltage power that may be directed to the propulsion unit 26, via the rotary electric machine 24, and for operating other electrical systems 28 in the vehicle 14. The rechargeable energy storage system 100 may include battery cells of different chemistries. In one example, the power inverter 22 is a three-phase three-wire voltage-source inverter. In some embodiments, the power inverter 22 may be part of a power inverter module of the electric vehicle 14. In order to generate tractive power with sufficient vehicle range and speed, the rechargeable energy storage system 100 in the electric vehicle 14 may be larger and higher in capacity than a nominal 12-volt starting, lighting, and ignition battery. In such an instance, the electric drive system 10 is a high-voltage electric drive system 10. Sensors and other monitoring elements (not shown) may be arranged to monitor electrical parameters (e.g., voltage, current) at various locations, and mechanical parameters (e.g., speed) at various other locations.

The rechargeable energy storage system 100 is attached to an underbody portion of the vehicle 14 in one embodiment. The rechargeable energy storage system 100 is located between left and right front wheels in one embodiment. Alternatively, the rechargeable energy storage system 100 is located between left and right rear wheels in one embodiment. Alternatively, the rechargeable energy storage system 100 is located between the front and rear wheels in one embodiment.

Referring again to FIG. 1, the rotary electric machine 24 electrically connects to the rechargeable energy storage system 100 via the high-voltage DC power bus 21 and the power inverter 22. The power inverter 22 is configured with control circuits including power transistors, e.g., IGBTs for transforming high-voltage DC electric power to high-voltage AC electric power and transforming high-voltage AC electric power to high-voltage DC electric power. The power inverter 22 may employ pulse width-modulating (PWM) control of the IGBTs to convert stored DC electric power originating in the rechargeable energy storage system 100 to AC electric power to drive the rotary electric machine 24 to generate torque. Similarly, the power inverter 22 converts mechanical power transferred to the rotary electric machine 24 to DC electric power to generate electric energy that is storable in the rechargeable energy storage system 100, including as part of a regenerative braking control strategy. The power inverter 22 receives motor control commands and controls inverter states to provide the motor drive and regenerative braking functionality. In one embodiment, a DC/DC electric power converter electrically connects to the high-voltage DC power bus 21 to provide electric power to a low-voltage battery via a low-voltage bus. The low-voltage battery electrically connects to an auxiliary power system to provide low-voltage electric power to low-voltage systems on the vehicle, including, e.g., electric windows, HVAC fans, seats, and other devices. The controller 40 is operatively connected to the power inverter 22 to control transfer of electric power between the rechargeable energy storage system 100 and a plurality of radially oriented electrically conductive windings of a stator of the rotary electric machine 24. The controller 40 controls the power inverter 22 to sequentially electrically activate electrically conductive windings to exert a rotating magnetic force on a rotor of the rotary electric machine 24 to effect rotation, or to react torque to retard rotation during regenerative operation.

Motors, generators, and other types of electric machines are often embodied as alternating current (AC) torque-generating devices. When the rotary electric machine is energized by a direct current (DC) voltage from a multi-cell battery pack or other DC power supply, a power inverter produces a desired polyphase AC output voltage. For example, a three-phase AC power inverter uses three separate phase inverters each having semiconductor switching components, e.g., IGBTs, MOSFETs, or thyristors. The on/off states of the switching components for a given electrical phase are controlled to produce the desired AC output voltage. The AC output voltage is thereafter supplied to a corresponding phase winding of the rotary electric machine.

Referring again to FIG. 1, the electric drive system 10 includes controller C 40 having a processor P and memory M that have been adapted to regulate the operation of various onboard systems and components in the vehicle 14. The controller C 40 is communicatively connected with the power inverter 22 to control the rotary electric machine 24 to control bi-directional transfer of energy between the rechargeable energy storage system 100 and the rotary electric machine 24 in either a motoring mode or a regenerative mode. The rotary electric machine 24 may operate using a three-phase AC current. In such an instance, the power inverter 22 is governed by the controller C 40 to convert the DC voltage (provided by the rechargeable energy storage system 100) to a three-phase AC voltage for use by the rotary electric machine 24 to generate torque when operating in the motoring mode. In the regenerative mode, the power inverter 22 converts AC power from the rotary electric machine 24 to DC power compatible with and storable on the rechargeable energy storage system 100. It is understood that the electric drive system 10 may include additional components not shown.

The various components of the electric drive system 10 may be in communication with the controller C 40 (and each other) via a wireless network 30, which may be a short-range network or a long-range network. Additionally, the various components of the electric drive system 10 may include physical wired connections. The wireless network 30 may be a communication BUS, which may be in the form of a serial Controller Area Network (CAN-BUS). The wireless network 30 may incorporate a Bluetooth™ connection, a Wireless Local Area Network (LAN) which links multiple devices using a wireless distribution method, a Wireless Metropolitan Area Network (MAN) which connects several wireless LANs or a Wireless Wide Area Network (WAN). Other types of connections may be employed.

The controller C 40 is programmed to receive a torque command in response to an operator input (e.g., through an accelerator pedal or brake pedal) or an automatically fed input condition monitored by the controller C 40. Upon receipt of the torque command, the controller C 40 is programmed to transmit a command signal to the power inverter 22 to regulate a transfer of electrical power between the rechargeable energy storage system 100 and the rotary electric machine 24. One technique employed to obtain a variable frequency, variable voltage or variable power from a power inverter 22 operating from a fixed voltage DC power source, such as the rechargeable energy storage system 100 is the pulse width modulation (“PWM” hereinafter) technique. The switching frequency of the PWM signal determines how fast the PWM completes a cycle, and therefore how fast it switches between high and low states. In other words, the PWM switching frequency corresponds to the rate at which the DC voltage is switched on and off during the PWM process in a switching power supply. There are various PWM techniques which may be implemented, such as for example, sinusoidal PWM (SPWM), space vector PWM (SVPWM), zero-vector modulation (ZVM) and discontinuous PWM (DPWM). These techniques differ in terms of their voltage linearity range, ripple voltage/current, switching losses, and high frequency common mode voltage or current properties.

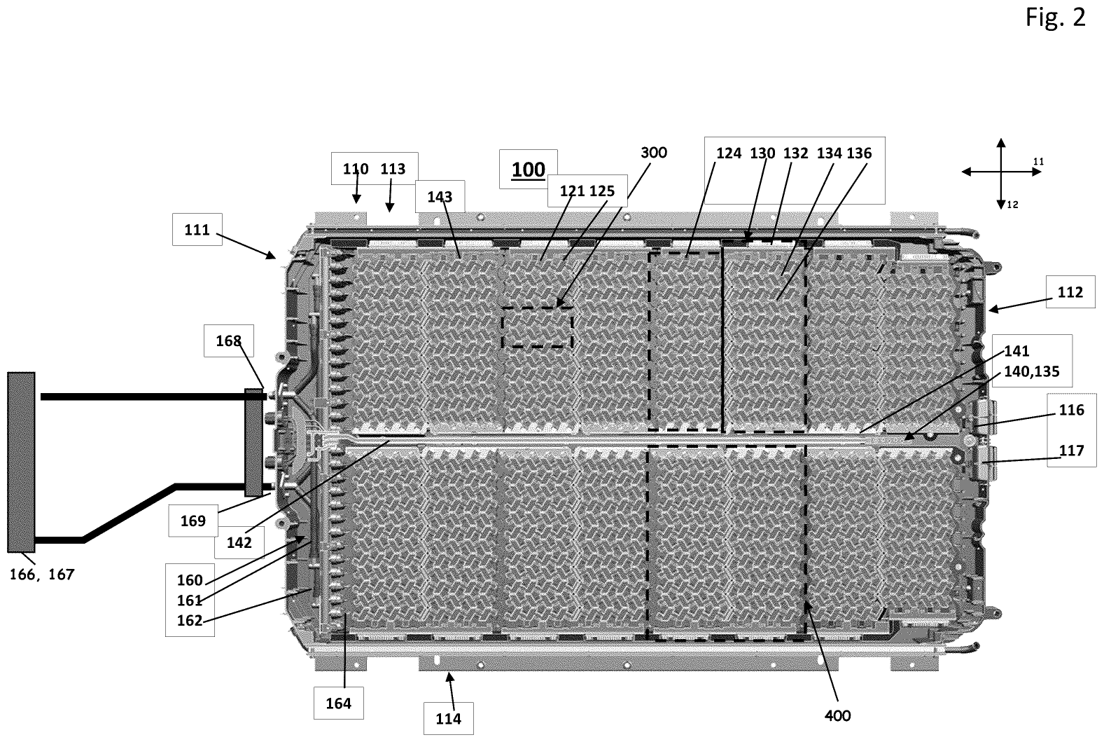

FIGS. 2, et seq., schematically illustrate elements of an embodiment of the rechargeable energy storage system 100 that is described with reference to FIG. 1. The rechargeable energy storage system 100 is composed of an electrical power system 120 and a thermal management system 160 that are arranged in an enclosure 110. The electrical power system 120 is composed of a plurality of cylindrical-shaped battery cells 121 that are arranged into a plurality of cell modules 130 and disposed in an enclosure 110. The plurality of cell modules 130 are symmetrically arranged around a longitudinally-oriented spine 135 that is centrally located in the enclosure 110 in the lateral direction.

The enclosure 110 is a rectangularly-shaped device that provides a housing and mounting for various elements of the rechargeable energy storage system 100. The enclosure 110 may be fabricated as a unitary device, or as an assembled device. The enclosure 110 has a first end 111 that may be arranged towards a nominal front of the vehicle 14 described with reference to FIG. 1, a second end 112 that may be arranged towards a nominal rear of the vehicle 14, a first, rightward side 113, and a second, leftward side 114.

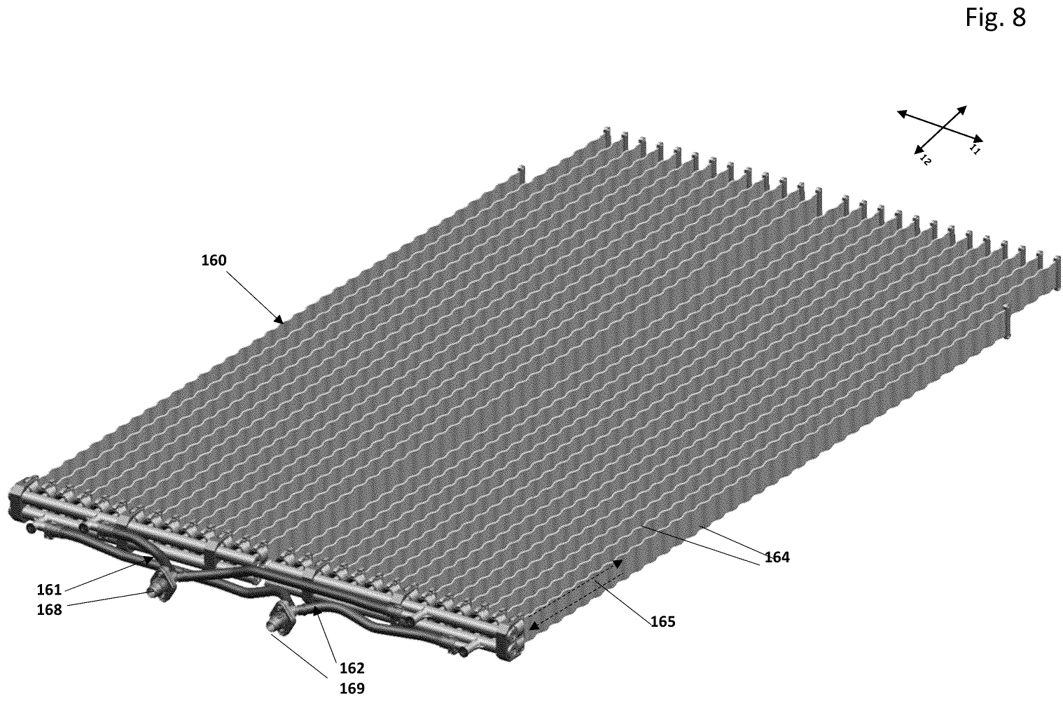

As illustrated with reference to FIGS. 2 and 8, the thermal management system 160 includes first and second fluidic manifolds 161, 162, respectively, that are fluidly coupled to a plurality of longitudinal heat exchange plates 164, and are also fluidly coupled to an external heat exchanger 166, e.g., a liquid/air heat exchanger. A fluidic pump 167 circulates a liquid coolant between the plurality of longitudinal heat exchange plates 164 and the external heat exchanger 166. A fluidic heating device may be incorporated to provide supplemental heat to the liquid coolant.

The plurality of longitudinal heat exchange plates 164 are ribbon-shaped cooling plates having first and second flow couplers 168, 169, respectively, that couple to internal flow channels 165. The arrangement of the first and second flow couplers 168, 169 and internal flow channel 165 on each of the longitudinal heat exchange plates 164 facilitates a down-and-back circulation of the coolant. The first and second flow couplers 168, 169 fluidly couple to a respective one of the first and second fluidic manifolds 161, 162 to effect flow of coolant through the internal flow channels 165. The plurality of longitudinal heat exchange plates 164 extend longitudinally from the first fluidic manifold 161 and are interleaved between adjacent pairs of the battery cells 121 to physically contact and thus thermally couple to the outer surfaces of the plurality of cylindrical-shaped battery cells 121. As arranged, and as shown with reference to FIG. 2, each of the battery cells 121 physically contacts and thus thermally couples to two of the longitudinal heat exchange plates 164. The thermal management system 160 thermally interacts with the plurality of battery cells 121 to remove heat or add heat thereto.

The thermal management system 160 is designed for overall structural integration into the rechargeable energy storage system 100 and hardware integration efficiency with a low profile design. This arrangement with the first and second fluidic manifolds 161, 162 being arranged on the first end 111 of the enclosure 110 means that there is little or no effect on packaging of the enclosure 110 on the first and second sides 113, 114, or the second end 112 or the corners. The first and second fluidic manifolds 161, 162, are sized and design to provide balanced flow of coolant through the longitudinal heat exchange plates 164 of the thermal management system 160 while minimizing packaging space. The longitudinal arrangement is also readily scalable to accommodate enclosures 110 for variants that have different lengths or widths, and also accommodate variants in height or diameters of the cylindrical-shaped battery cells 121.

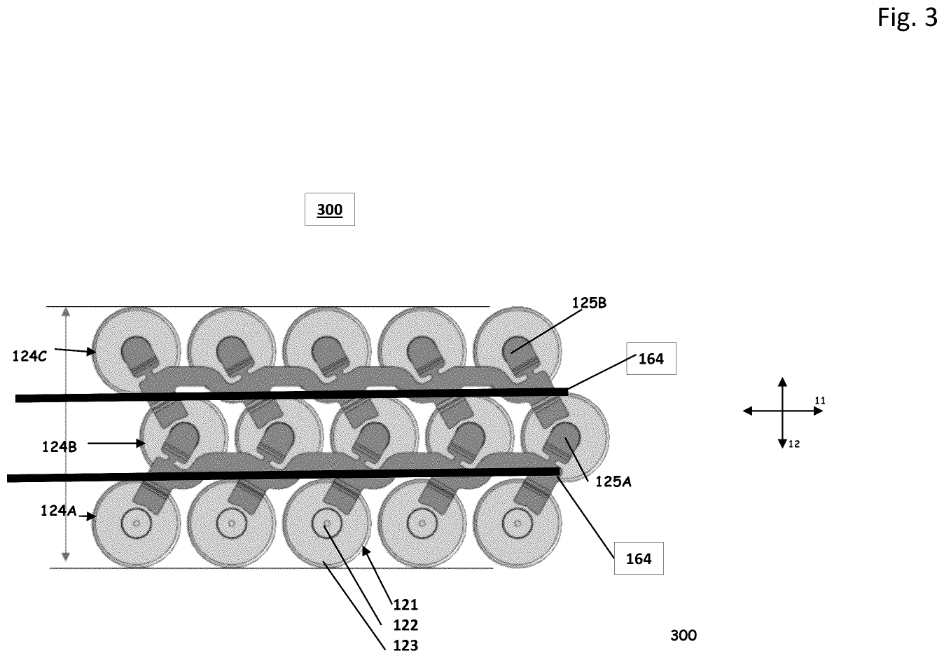

Referring again to FIG. 2, the rechargeable energy storage system 100 is arranged as a rechargeable electrochemical energy storage device, and the plurality of cylindrical-shaped battery cells 121 may be composed as lithium manganese, lithium-ion phosphate, lithium cobalt, lithium-nickel based cells, by way of non-limiting examples. Each of the cylindrical-shaped battery cells 121 includes a positive terminal 122 and a negative terminal 123, as indicated with reference to FIG. 3.

Electrical connectivity between a positive device terminal 116 and a negative device terminal 117 is achieved employing an electric power bus 140 that includes a plurality of first interconnect board (ICB) busbars 141 and a second ICB busbar 142, and a plurality of end collectors 143.

The electric power bus 140 is arranged in the longitudinally-oriented spine 135 that is centrally-located in the lateral direction, wherein the electric power bus 140 includes a plurality of the first ICB busbars 141 and the second ICB busbar 142.

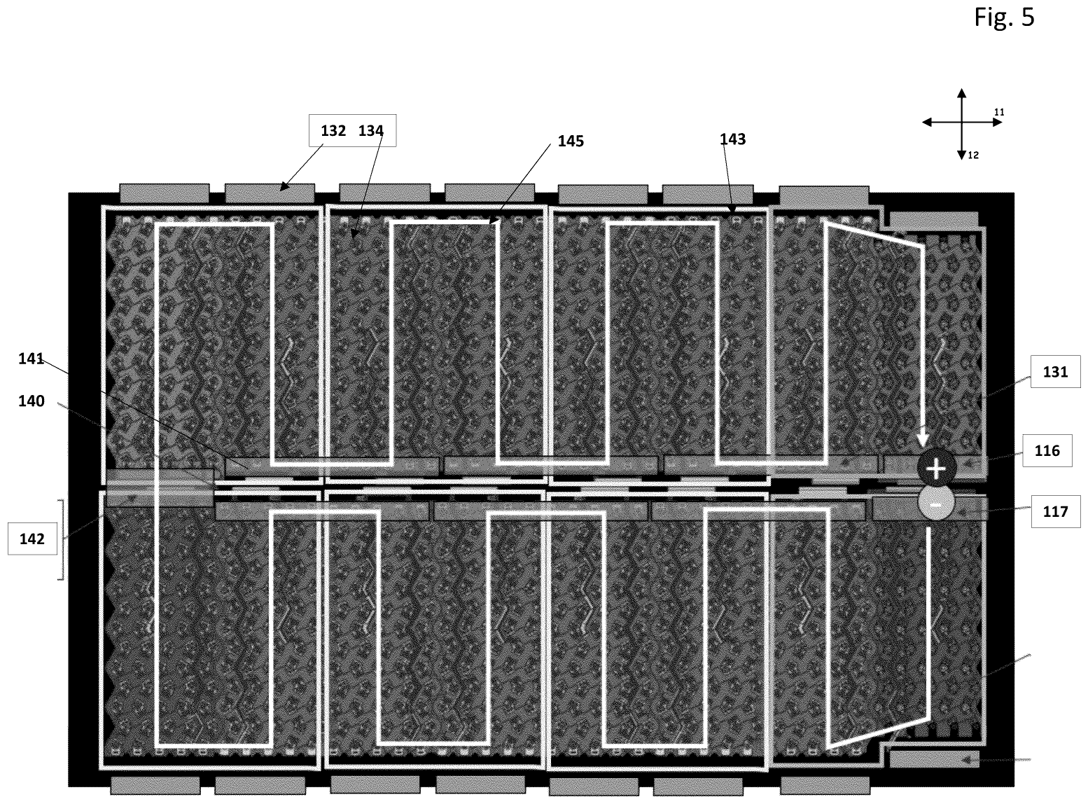

The plurality of first ICB busbars 141, the second ICB busbar 142, and the plurality of end collectors 143 are arranged to electrically connect the plurality of cell modules 130 in series in a serpentine arrangement 145 between the positive device terminal 116 and the negative device terminal 117 to supply electrical power. The serpentine arrangement 145 to electrically connect the plurality of cell modules 130 in series between the positive device terminal 116 and the negative device terminal 117 is depicted with reference to FIG. 5.

FIG. 3 shows a portion 300 of one of the cell modules 130 that is illustrated with reference to FIG. 2 to illustrate an arrangement of the longitudinally-oriented collectors 125 to electrically connect the cylindrical-shaped battery cells 121 to form the plurality of cell modules 130.

The cylindrical-shaped battery cells 121 are disposed in rows that are parallel to the longitudinal axis 11 to accommodate the plurality of longitudinal heat exchange plates 164 of the thermal management system 160. The cylindrical-shaped battery cells 121 are arranged into a plurality of cell modules 130 that are perpendicular to the longitudinal axis 11 and parallel to the lateral axis 12. Each of the cell modules 130 includes a cell monitoring unit (CMU) 132.

The CMU 132 includes a controller that communicates with a plurality of sensors that monitor environmental and operational parameters of the battery cells 121 and the cell module 130, including e.g., current, voltage, and temperature.

Each of the cell modules 130 is formed by electrically connecting a plurality of cell subsets 124 of the battery cells 121 in series employing the collectors 125. As shown with reference to FIG. 3, three cell subsets 124A, 124B, 124C are arranged in parallel, each with a quantity of five of the battery cells 121. A first collector 125A electrically connects the negative terminals 123 of the first cell subset 124A to the positive terminals 122 of the second cell subset 124B, and a second collector 125B electrically connects the negative terminals 123 of the second cell subset 124B to the positive terminals 122 of the third cell subset 124C. Additional cell subsets 124 may be readily accommodated by use of the collector 125, thus facilitating expansion or contraction in the lateral direction for a design variant.

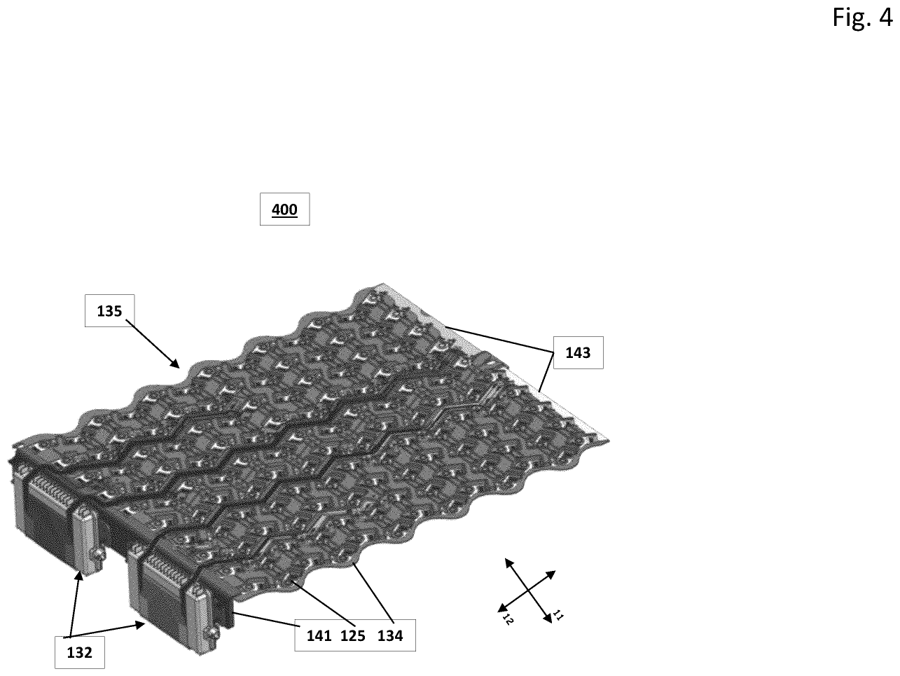

FIG. 4 shows a portion 400 of the cell modules 130 that are illustrated with reference to FIG. 2 to illustrate an arrangement of adjacent SLA (sense line assembly) devices 136, 136′. Each SLA device 136 assembles onto one of the cell modules 130, and includes CMU 132, an interconnect board (ICB) 134, a plurality of the longitudinally-oriented collectors 125 arranged in parallel to electrically connect the cylindrical-shaped battery cells 121, a wiring harness and the plurality of sensors that monitor environmental and operational parameters of the battery cells 121. The SLA devices 136 connect to one of the end collectors 143, and one of the first ICB busbars 141 to facilitate the serpentine arrangement 145 described with reference to FIG. 5 to electrically connect the plurality of cell modules 130 in series between the positive device terminal 116 and the negative device terminal 117. This arrangement facilitates the CMU 132 and/or the ICB 134 to be decoupled, and also facilitates manufacturability by providing ready access during assembly.

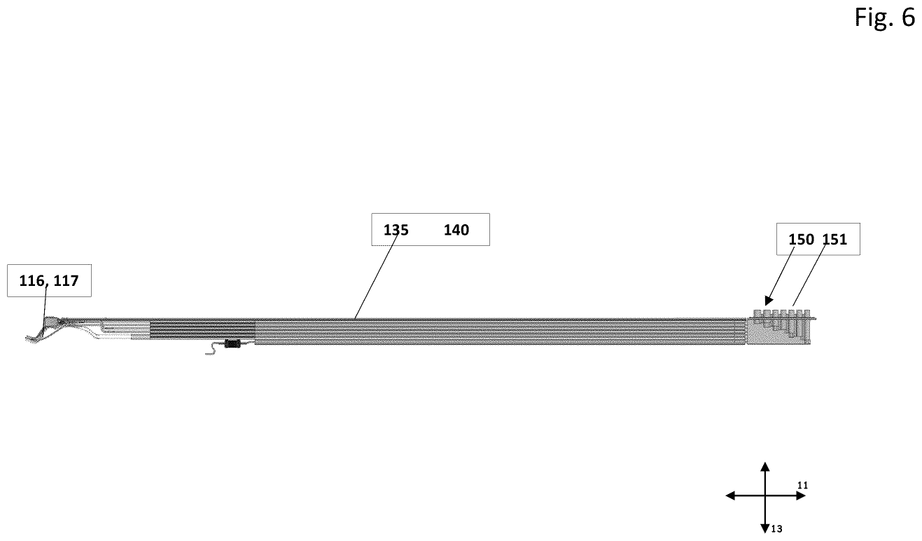

FIG. 6 illustrates an embodiment of the longitudinally-oriented spine 135, with the electric power bus 140, wherein the electric power bus 140 includes a plurality of first busbars and a second busbar, which are arranged in a vertical stack. The longitudinally-oriented spine includes a bus connector on the first end 111, with the positive device terminal 116 and the negative device terminal 117 arranged thereon. A battery disconnect unit (BDU) interface 150 is arranged on the second end 112.

The positive device terminal 116 and the negative device terminal 117 electrically connect to the high-voltage DC power bus 21 (From FIG. 1) via the BDU interface 150. The longitudinally-oriented spine with the electric power bus arranged in a vertical stack enables efficient packaging in the lateral dimension and the vertical dimensions, which may facilitate improved electric power density. With the busbars being stacked, fasteners in the BDU interface 150 may be bolted vertically, which facilitates automated assembly processes.

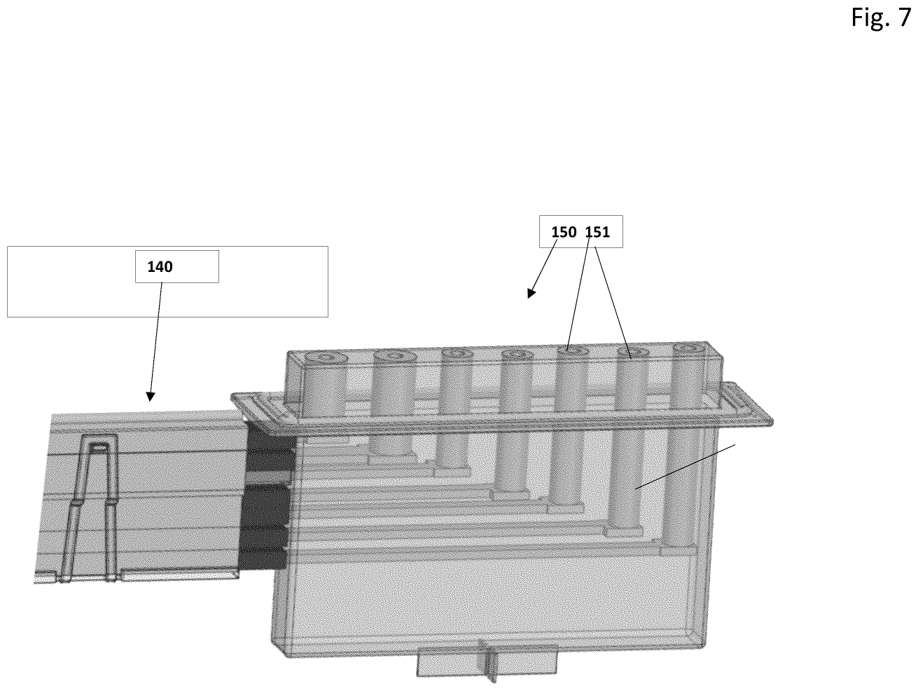

The BDU interface 150 is illustrated in detail with reference to FIG. 7, and is arranged on the second end 112 of the longitudinally-oriented spine 135, and electrically connects to a BDU device for activation. The BDU interface 150 includes busbars having friction welded bosses 151 that are vertically arranged to enable a 90° bend, which facilitates vertically driven fasteners. The BDU interface 150 includes a plastic injection molded or potted piece to maintain voltage isolation between the busbars. This provides a sealed interface between the internal elements of the rechargeable energy storage system 100 while maintaining and efficient packaging size and providing high voltage electrical isolation.

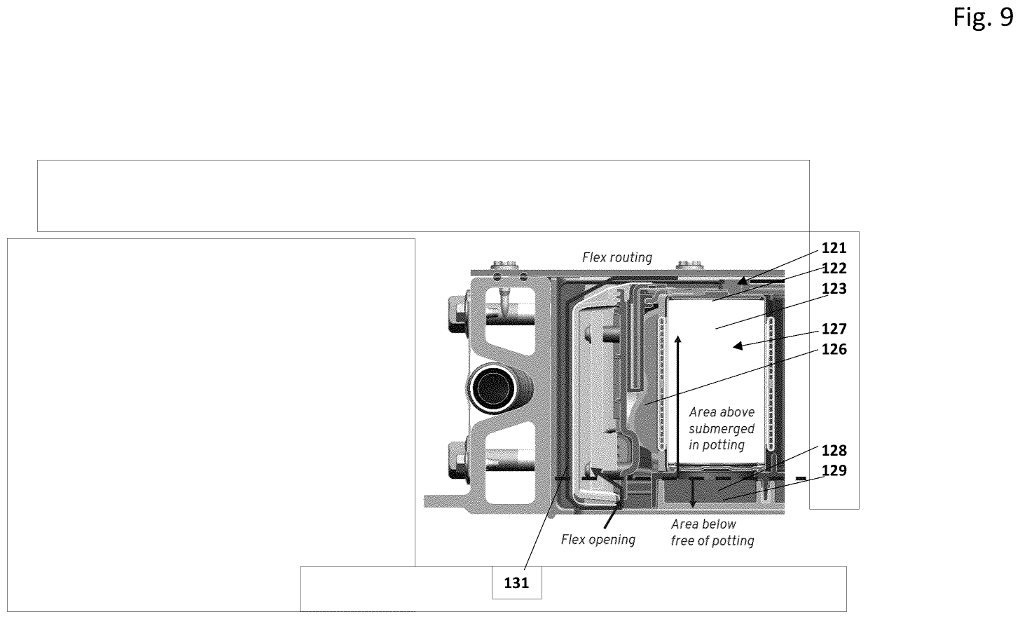

FIG. 9 schematically illustrates a cutaway portion of the rechargeable energy storage system 100, including one of the cells 121 having positive terminal 122 and negative terminal 123, ICB 134, and enclosure 110. An upper portion 127 of the cell 121 is encapsulated in a potting material 126, and a lower portion 128 of the cell 121 in a void area 129 that is void area that is defined by the potting material 126 that encapsulates the upper portion 127 of the battery cell 121 and the enclosure 110. A flex routing design facilitates direct connection to the ICB 134 via a flexible printed circuit (FPC) 131 without compromising the seal created by the potting material 126. This arrangement may be an element of a thermal runaway protection (TRP) strategy. The opening for the FPC 131 is outside the potting zone, and may serve as a gas sensing path.

As described herein, the battery design provides a hybrid orientation of the electrical system and thermal system to enable more efficient cell integration and meet energy and allowable packaging dimensions.

The battery design enables efficient packaging of the battery cells in the vehicle y dimension and allows flexibility of total cell count in the pack.

The dual longitudinal serpentine electrical bussing design may facilitate a packaging efficient repeating interconnect board and sense line assembly, reduces bussing/wire length to BDU for mass reduction and packaging efficiency, and improve EMC by symmetric design.

The SLA and CMU integration may enable efficient packaging space, meet EMC and optimize wire length for complexity and mass reduction.

The arrangement of the HV busing in the spine may enable efficient packaging and assembly automation by bolting fasteners vertically.

The BDU header design for connection of the busbars to the BDU may enables easy assembly, efficient packaging space, and sealing functions to the BDU.

The thermal system may enable efficient pack integration and thermal hardware low-profile design employing dual ribbon cooling, reduction of the number of seals, efficient manifold sizing, easy assembly and scalability for alternative pack length and cell heights.

The term “controller” and related terms such as microcontroller, control, control unit, processor, etc. refer to one or various combinations of Application Specific Integrated Circuit(s) (ASIC), Field-Programmable Gate Array(s) (FPGA), electronic circuit(s), central processing unit(s), e.g., microprocessor(s) and associated non-transitory memory component(s) in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning, buffer circuitry and other components, which can be accessed by and executed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms, and similar terms mean controller-executable instruction sets including calibrations and look-up tables. Each controller executes control routine(s) to provide desired functions. Routines may be executed at regular intervals, for example every 100 microseconds during ongoing operation. Alternatively, routines may be executed in response to occurrence of a triggering event. Communication between controllers, actuators and/or sensors may be accomplished using a direct wired point-to-point link, a networked communication bus link, a wireless link, or another communication link. Communication includes exchanging data signals, including, for example, electrical signals via a conductive medium; electromagnetic signals via air; optical signals via optical waveguides; etc. The data signals may include discrete, analog and/or digitized analog signals representing inputs from sensors, actuator commands, and communication between controllers.

While the best modes for carrying out the disclosure have been described in detail, those familiar with the art to which this disclosure relates will recognize various alternative designs and embodiments lying within the scope of the appended claims. It is intended that the matter contained in the above description and/or shown in the accompanying drawings shall be interpreted as illustrative only and not as limiting.

What is claimed is:

1. A rechargeable energy storage system, comprising:
a plurality of cylindrical-shaped electrochemical battery cells (battery cells), wherein the plurality of battery cells are disposed in an enclosure, and wherein the plurality of battery cells are arranged into a plurality of cell modules;
a plurality of longitudinally-oriented collectors, wherein the plurality of longitudinally-oriented collectors are arranged to electrically connect the battery cells arranged in the plurality of cell modules;
a plurality of end collectors arranged on first and second sides of the enclosure;
a positive device terminal and a negative device terminal;
an electric power bus arranged in a longitudinally-oriented spine, wherein the electric power bus includes a plurality of first busbars and a second busbar;
wherein the plurality of first busbars, the second busbar, and the plurality of end collectors are arranged to electrically connect the plurality of cell modules in series between the positive device terminal and the negative device terminal; and
a thermal management system including first and second fluidic manifolds that are fluidly coupled to a plurality of longitudinally-oriented heat exchange plates;
wherein the plurality of longitudinally-oriented heat exchange plates are arranged to physically contact a portion of an outer surface of the plurality of battery cells.

2. The rechargeable energy storage system of claim 1, comprising the plurality of first busbars, the second busbar, and the plurality of end collectors being arranged in a serpentine configuration to electrically connect the plurality of cell modules in series between the positive device terminal and the negative device terminal.

3. The rechargeable energy storage system of claim 1, further comprising a potting compound, wherein the potting compound is arranged to encapsulate only an upper portion of the plurality of battery cells and the plurality of longitudinally-oriented collectors within the enclosure.

4. The rechargeable energy storage system of claim 1, wherein the positive device terminal and the negative device terminal are arranged proximal to a first end of the enclosure.

5. The rechargeable energy storage system of claim 1, further comprising a plurality of cell monitoring controllers arranged to monitor the plurality of cell modules.

6. The rechargeable energy storage system of claim 5, wherein each of the plurality of cell monitoring controllers is arranged to monitor electrical parameters and environmental parameters of a respective one of the plurality of cell modules.

7. The rechargeable energy storage system of claim 1, wherein the plurality of cell modules project laterally outwardly from the longitudinally-oriented spine.

8. The rechargeable energy storage system of claim 1, further comprising the battery cells of one of the plurality of cell modules being arranged into a plurality of subsets that are arranged in parallel, wherein one of the plurality of longitudinally-oriented collectors is arranged to electrically connect a first of the plurality of subsets of the battery cells to second of the plurality of subsets of the battery cells.

9. The rechargeable energy storage system of claim 1, wherein the plurality of cell modules are arranged symmetrically around the longitudinally-oriented spine.

10. The rechargeable energy storage system of claim 1, wherein the plurality of longitudinal heat exchange plates physically contact the portion of the outer surface of the plurality of battery cells to thermally couple to the plurality of battery cells.

11. The rechargeable energy storage system of claim 1, further comprising a potting material that encapsulates an upper portion of the plurality of battery cells.

12. The rechargeable energy storage system of claim 11, further comprising a void area that is defined by the potting material that encapsulates the upper portion of the plurality of battery cells, and the enclosure.

13. The rechargeable energy storage system of claim 1, wherein the plurality of first busbars of the electric power bus are arranged in a vertical stack in the longitudinally-oriented spine.

14. The rechargeable energy storage system of claim 1, wherein the plurality of first busbars of the electric power bus electrically connect to a plurality of vertically-arranged bosses.

15. The rechargeable energy storage system of claim 14, further comprising a battery disconnect unit, wherein the plurality of vertically-arranged bosses electrically connect to the battery disconnect unit.

16. A vehicle, comprising:
a rechargeable energy storage system electrically connected to an electric drive system coupled to a propulsion unit;
wherein the rechargeable energy storage system includes:
a plurality of cylindrical-shaped electrochemical battery cells (battery cells), wherein the plurality of battery cells are disposed in an enclosure, and wherein the plurality of battery cells are arranged into a plurality of cell modules;
a plurality of longitudinally-oriented collectors, wherein the plurality of longitudinally-oriented collectors are arranged to electrically connect the battery cells arranged in the plurality of cell modules;
a plurality of end collectors arranged on first and second sides of the enclosure;
a positive device terminal and a negative device terminal;
an electric power bus arranged in a longitudinally-oriented spine, wherein the electric power bus includes a plurality of first busbars and a second busbar;
wherein the plurality of first busbars, the second busbar, and the plurality of end collectors are arranged to electrically connect the plurality of cell modules in series between the positive device terminal and the negative device terminal; and
a thermal management system including first and second fluidic manifolds that are fluidly coupled to a plurality of longitudinally-oriented heat exchange plates;
wherein the plurality of longitudinally-oriented heat exchange plates are arranged to physically contact a portion of an outer surface of the plurality of battery cells.

17. A rechargeable energy storage system, comprising:
a plurality of electrochemical battery cells (battery cells), wherein the plurality of battery cells are disposed in an enclosure, and wherein the plurality of battery cells are arranged into a plurality of cell modules;
a plurality of collectors, wherein the plurality of collectors are arranged to electrically connect the battery cells arranged in the plurality of cell modules;
a plurality of end collectors arranged on first and second sides of the enclosure;
a positive device terminal and a negative device terminal;
an electric power bus arranged in a spine, wherein the electric power bus includes a plurality of first busbars and a second busbar;
wherein the plurality of first busbars, the second busbar, and the plurality of end collectors are arranged to electrically connect the plurality of cell modules in series between the positive device terminal and the negative device terminal; and
a thermal management system fluidly coupled to a plurality of heat exchange plates;
wherein the plurality of heat exchange plates are arranged to physically contact a portion of an outer surface of the plurality of battery cells.

18. The rechargeable energy storage system of claim 17, comprising the plurality of first busbars, the second busbar, and the plurality of end collectors being arranged in a serpentine configuration to electrically connect the plurality of cell modules in series between the positive device terminal and the negative device terminal.

19. The rechargeable energy storage system of claim 17, further comprising a potting compound, wherein the potting compound is arranged to encapsulate only an upper portion of the plurality of battery cells and the plurality of collectors within the enclosure.

20. The rechargeable energy storage system of claim 17, wherein the positive device terminal and the negative device terminal are arranged proximal to a first end of the enclosure.
